(19) United States
(12) Patent Application Publication
(10) Pub. No.: US 2009/0158648 A1
(43) Pub. Date: Jun. 25, 2009

(54) ROLLABLE MULCH MAT MADE OF RECYCLED MATERIAL AND RELATED MANUFACTURING METHODS

(76) Inventors: Richard C. Moore, JR., Charleston, SC (US); Sheila B. Jones, McGregor, TX (US)

Correspondence Address: TURNER PADGET GRAHAM & LANEY, P.A., P.O. BOX 1509, GREENVILLE, SC, 29602, US

(21) Appl. No.: 12/122,029

(22) Filed: May 16, 2008

Related U.S. Application Data
(63) Continuation-in-part of application No. 11/960,864, filed on Dec. 20, 2007.

(51) Int. Cl. A01G 13/02; A01G 29/00; B29C 33/40

(52) U.S. Cl. 47/32; 47/48.5; 47/9; 264/316

(57) ABSTRACT

A mulch mat made of recyclable material is provided having a mulch-appearing surface made of recycled material such as rubber and another surface made of a plant inhibiting fabric. The fabric extends beyond the mulch-appearing surface on at least one edge of the mat to provide an area upon which another of the mats may be positioned to prevent weed, grass and other plants from growing between the mats. In addition, the mulch mat may include fertilizer to nourish nearby trees, bushes and the like.

### CROSS REFERENCE TO RELATED APPLICATIONS

This application is a Continuation-In-Part of, and claims priority to, U.S. patent application Ser. No. 11/960,864, filed Dec. 20, 2007, the disclosure of which is hereby incorporated by reference.

### BACKGROUND

Landscape sheet layers may be utilized for a variety of landscaping applications, including to deter weed growth, to provide erosion control, and the like. For example, landscape sheet layers may be applied over soil of a landscape bed or other landscape region. Landscape sheets are often sold as roll goods, which are unrolled, cut and overlaid to fit the desired placement location. Alternately, landscape sheets may be delivered in a folded format.

Landscape sheets may be formed from a variety of materials. Such materials may include solid plastic sheets, which may be undesirable for some applications. Although they may block weed growth and promote erosion control, the solid plastic sheets do not allow air and water to penetrate the sheet and flow through to the underlying soil. Thus, solid plastic sheets may result in poor growing conditions and mold, as the soil is not allowed to “breathe” and water is not allowed to reach plant roots.

To address the foregoing problems, other landscape sheet layers have been formed from materials that allow air and water passage but still serve to deter weed growth, to provide erosion control, and/or to provide other beneficial landscaping properties. Materials that are air and water permeable are often referred to as “landscape fabrics.” Landscape fabrics may be formed, for example, from spunbound or woven materials. Exemplary materials include synthetic materials (such as polyethylene, polypropylene or polyester); natural materials; or combinations of synthetic and natural materials.

Regardless of the types of landscape sheet materials utilized, the landscape sheet materials typically do not have a natural or visually appealing effect for a landscape application. As such, additional materials are often placed on top of the landscape sheet material as part of a complete landscape application, thereby adding expense and time to a landscaping project. For example, loose organic mulching materials—such as bark mulch or nuggets, pine needles, coconut hulls (also called coir), or other organic materials—may be placed on top of a landscape sheet after the sheet material has been spread on a landscape area. Unfortunately, these mulching materials generally are bulky, difficult to transport, and difficult to spread. Moreover, these materials tend to require routine maintenance, as these loose mulching materials may be washed or blown away by rain or wind, may be eroded by exposure to the elements, or may fade over time.

### SUMMARY

The present disclosure is directed in general to a flexible, rollable multi-purpose lawn and garden mat made of recycled material such as rubber. The mat is used to create natural, but manicured, edges along walkways and around trees, shrubbery, flowerbeds, posts, poles, and the like to define lawn boundaries and to inhibit grass and weed growth along these edges and between the mats. In addition, the mats, may be used to create larger manicured areas or edges for situating water hose storage carts, outdoor garden supply sheds, playground equipment and the like in order to render mowing or trimming around and under such items unnecessary.

The rollable mulch mat is made, for example, by recycling a waste product such as used rubber tires. The mulch mat may have a variety of colors, for instance, brown, red, black or combinations of these and other colors. The mulch pad may be rolled or folded in such a way that a home improvement store, a garden store or the like need only use a limited amount of floor or shelf space compared to bulkier conventional lawn and garden products.

Evident from the foregoing introduction, the component parts and ingredients of the rollable mulch mat are simple and economical to manufacture and use. Other advantages of the disclosure will be apparent from the following description and the attached drawings or can be learned through practice of the various embodiments described below.

In a particular embodiment according to the disclosure, a flexible mulch mat includes a first surface including a plurality of rubber components configured to appear as mulch, the rubber components being irregularly sized, shaped and spaced relative to each other; a second surface in contact with the first surface, the second surface being configured for contact with ground to prevent plant growth therethrough; a section depending from the second surface extending beyond the first surface, the section being configured to underlie an abutment to prevent plant growth therethrough; and a fertilizer disposed about the rubber components, the fertilizer configured to leach through the second surface to the ground. In this aspect, the rubber components of the first surface may be rubber buffings and/or rubber granules derived from rubber tires.

The rubber buffings may be randomly oriented within the mat, resulting in the angular positioning of the rubber buffings relative to the lower planar surface and in the creation of an uneven, or jagged, upper surface. The thickness of the mat, as measured from the lower planar surface to the upper surface, varies from point to point, due to the irregular texture produced by the randomly projecting rubber buffings. The rough texture and variable thickness produce an appearance characteristic of natural mulch.

Also in this embodiment, the second surface may be a polypropylene material, a polyethylene material, a polyester material and combinations of these and other materials.

The first and second surfaces may be between about 0.100 inches to about 0.250 inches in cross-section. Also, the first surface may be about 12 inches to about 48 inches in width and about 4 feet to about 10 feet in length.

The second surface may project beyond the first surface from about 1 inch to about 2 inches.

Further, in this embodiment the abutment may be formed between the flexible mulch mat and an adjoining mulch mat.

The flexible mulch mat may also include an adhesive to adhere the first surface to the second surface.

In another embodiment according to the disclosure, a method of manufacturing a flexible mulch mat may include providing a forming surface; mixing together a rubber component and a binder to form a matrix having a mulch-like appearance; and attaching a base to the matrix to form a flexible mat on the forming surface.

The method may include mixing a fertilizer in the matrix and/or applying the fertilizer to the flexible mat.

The method may further include forming a border extending from the base beyond the matrix.

The method may also include rolling the mat into a tubular form.

The method may further include rolling the mat into a tubular form having a diameter of about five inches to about ten inches.

### BRIEF DESCRIPTION OF THE DRAWINGS

The above and other aspects and advantages of the present disclosure are apparent from the detailed description below in combination with the drawings, in which:

FIG. 1 is a perspective view of flexible mulch mats shown in an intended use according to an aspect of the disclosure;

FIG. 2 is a perspective view of one of the flexible mulch mats as in FIG. 1 shown in a rolled condition;

FIG. 3 is a perspective view of one of the flexible mulch mats as in FIG. 2 being unrolled;

FIG. 4 is a perspective view of the flexible mulch mats as in FIG. 1 being unrolled together, particularly showing an overlapping operation of a border portion of one the flexible mulch mats;

FIG. 5A is an elevational view of a cross-section of the flexible mulch mat taken along line V-V in FIG. 3;

FIG. 5B is a perspective view of the flexible mulch mat;

FIG. 6 is a perspective view of one the flexible mulch mats as in FIG. 1 being prepared for installation according to another aspect of the disclosure;

FIG. 7 is a schematic view of a manufacturing line showing a process of forming flexible mulch mats as in FIGS. 1-6 according to a further aspect of the disclosure;

FIG. 8 is a schematic view of a manufacturing line showing another process of forming flexible mulch mats as in FIG. 9 according to a further aspect of the disclosure;

FIG. 9 is a perspective view of flexible mulch mats shown in an intended use according to a further aspect of the disclosure; and

FIG. 10 is an elevational view of a cross-section of the flexible mulch mat taken along line X-X in FIG. 9.

### DETAILED DESCRIPTION

Detailed reference will now be made to the drawings in which examples embodying the present disclosure are shown. The detailed description uses numerical and letter designations to refer to features of the drawings. Like or similar designations of the drawings and description have been used to refer to like or similar parts of various embodiments according the disclosure.

The drawings and detailed description provide a full and detailed written description of the disclosure, the manner and process of making and using various embodiments, and the best mode of carrying out the disclosure, to enable one skilled in the pertinent art to make and use the various embodiments. However, the examples set forth in the drawings and detailed description are provided by way of illustration only and are not meant as limitations of the disclosure. The present disclosure thus includes any modifications and variations of the following examples as fall within the scope of the appended claims and their equivalents.

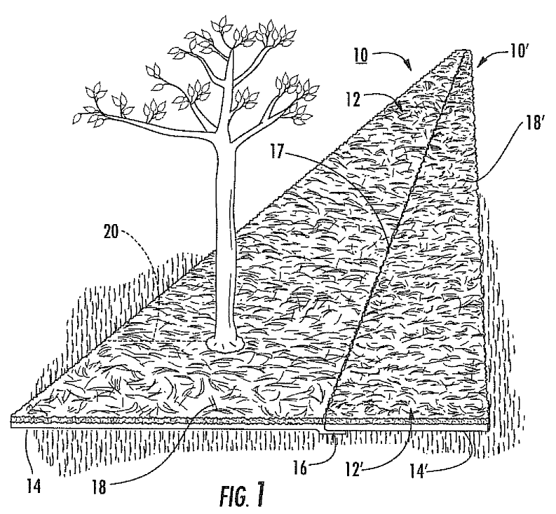

Turning now to FIGS. 1-6, a flexible mulch pad or mat is shown, which is designated in general by the element number 10 and which generally includes an upper or mulch surface 12 and a fabric or base 14. The base 14 includes an underlying section 16, also referred to herein as an edge or a border, which extends beyond the dimensions of the mulch surface 12 on at least one side. For ease of explanation, the portion of the base that is covered by the mulch surface 12 will be referred to as base 14, while the uncovered portion of the base that extends beyond the mulch surface 12 will be referred to as the border, or edge, 16.

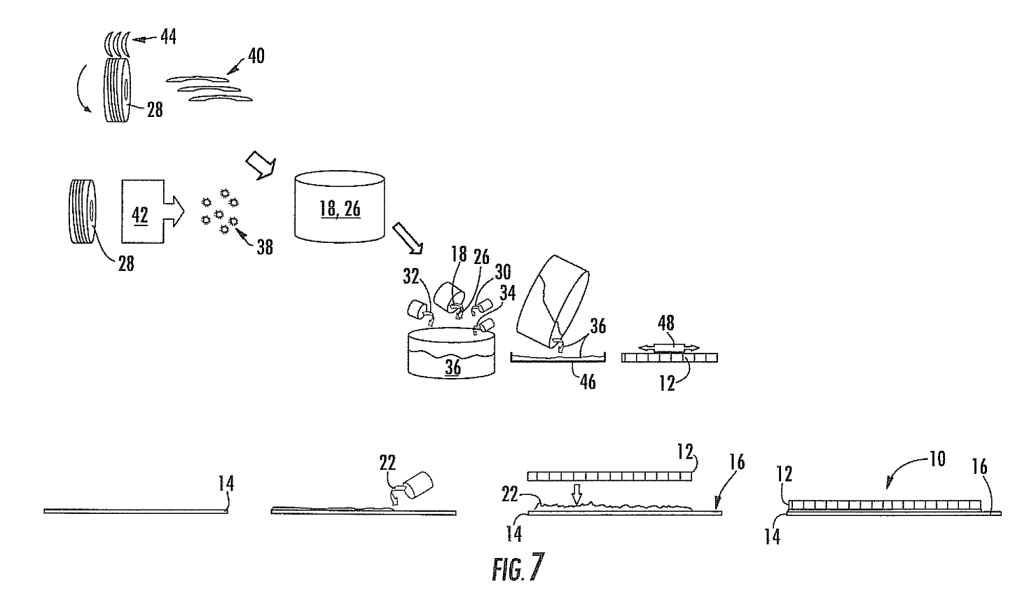

According to exemplary manufacturing processes, shown in FIG. 7 and described in detail below, the flexible mulch mat 10 may be manufactured by chipping, cutting, or chopping used tires (or other recyclable rubber or synthetic materials) into pieces 18 made to appear as wood chips, wood shreds, wood nuggets, pebbles, stones, pine needles, or other natural materials. The pieces 18 form the mulch surface 12 and are attached to the base 14 by the processes discussed below.

In use, the flexible mulch pad 10 appears as a natural mulch-covered area. The flexible mulch pad 10 is sufficiently durable to withstand various weather conditions and lasts many times longer than natural mulch, which tends to fade, decompose and become scattered due to wind and foot traffic. Due to its border 16 and other user-friendly installation characteristics, the flexible mulch pad 10 may be used easily with other flexible mulch pads to create relatively large, weed-resistant, covered areas.

With particular reference to FIG. 1, the exemplary flexible mulch mat 10 is rectangular in shape and optionally has been slit as indicated by element number 20 to fit around a tree in this example. This illustration shows a configuration that results when a gardener or groundskeeper opts to use a pair of flexible mulch mats 10, 10′ to create a relatively large covered area. As shown, each of the flexible mulch mats 10, 10′ includes respective surfaces 12, 12′ having pieces 18, 18′ as briefly introduced above. As further shown, the flexible mulch mat 10′ overlies the border 16 of the flexible mulch mat 10 to create a weed-blocking barrier between the flexible mulch mats 10, 10′. Without the border 16 between the flexible mulch mats 10, 10′, weeds, grass and other undesired plant life may readily grow between a seam or abutment 17 created between the flexible mulch mats 10, 10′.

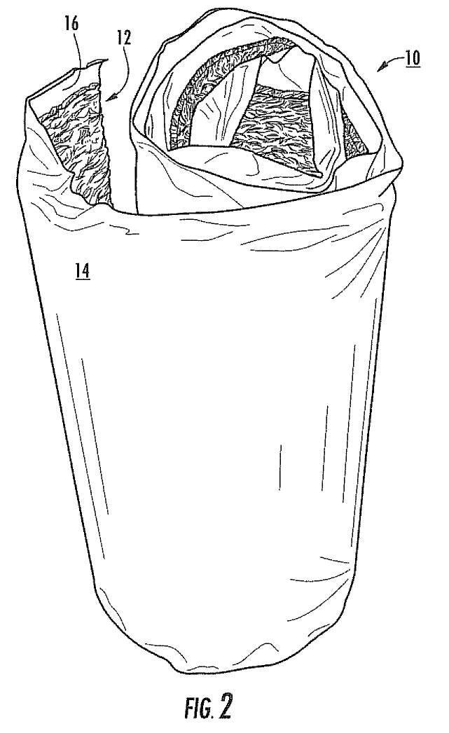

Although many sizes and shapes of the flexible mulch mat 10 are possible, the flexible mulch mat 10 may have a width of from about eighteen to about forty-eight inches and a length of from about four to about ten feet. As shown, the surface 12 and base 14 of the mulch mat 10 have a combined, relatively thin cross-section of about 0.100 inches to about 0.250 inches. The pliant substrate (base 14) and the thin layer of compressible rubber components (surface 12) provide the mulch mat 10 with sufficient flexibility to be rolled into a tubular shape, as shown in FIG. 2.

Being able to roll mulch mats of 6-10 feet in length (or longer) into tubular forms having diameters of only about seven inches reduces retail floor space required to store and display the mats 10 and also provides a consumer with relatively compact packages for carrying and transporting the mats 10 from the retail store to the project site. Additionally, less material is required to manufacture the mats 10, which results in reduced manufacturing costs and, ultimately, savings to the consumer.

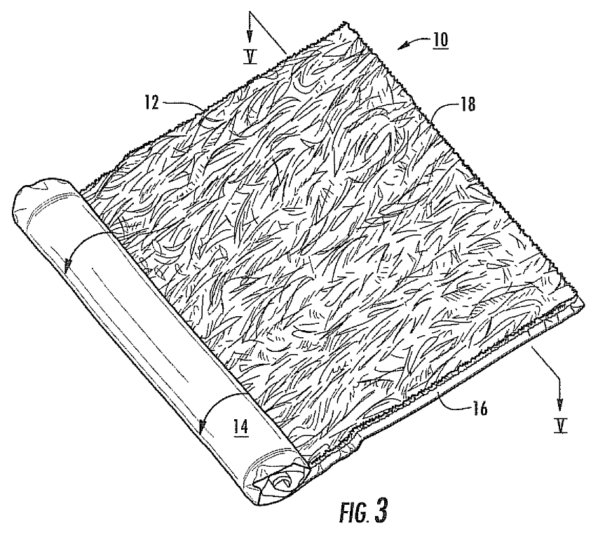

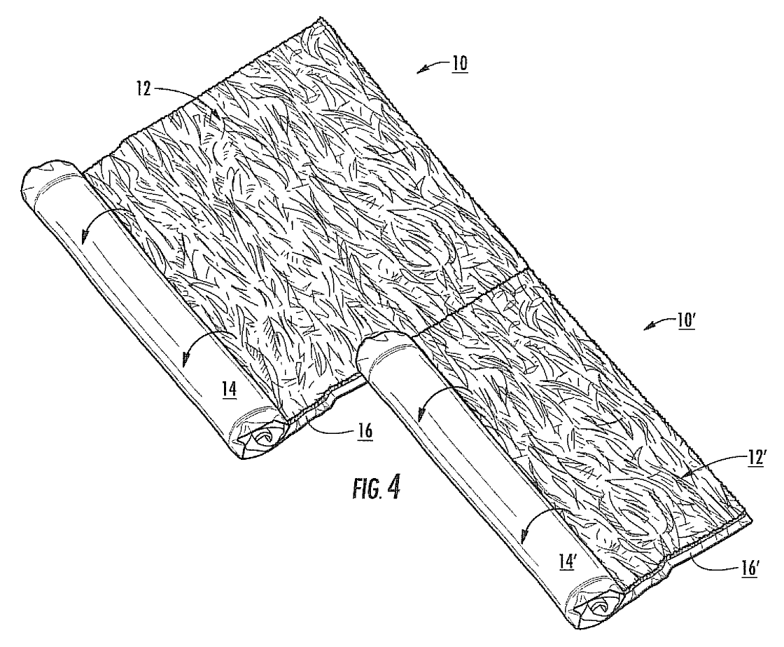

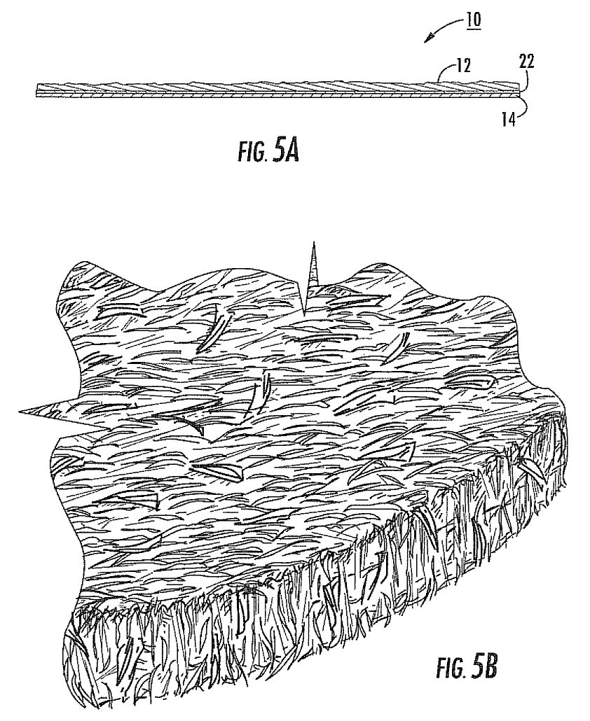

As shown in FIGS. 3 and 4, the base 14 and the border 16 of the flexible mulch mat 10 are made from a fabric, examples of which include a non-woven polypropylene material or a UV-treated polyethylene material. An example of the latter, a UV-treated polyethylene material, is sold under the name PRO WeedBlock® Landscape Fabric by Easy Gardener, Inc. of Waco, Tex. Other exemplary materials may include synthetic materials (such as polyester); natural materials (such as compressed or non-compressed organic material); or a combination of natural and synthetic materials. The base 14 and the border 16 block sunlight and therefore prevent growth of weeds, grass, and other plant life. As introduced above, the base 14 is attached to the pieces 18 by melt processes, adhesives or the like. For instance, the pieces 18 making up the surface 12 may be adhered to the base 14 by an adhesive 22 as shown in FIG. 5A.

FIG. 4 most clearly shows the border 16 extending from the base 14 by about one to two inches, although the border 16 may be narrower or wider as required. Stated another way, a length, a width or an area of the surface 12 may be smaller than the base fabric to form the border 16. Although not shown, the border 16 may extend from two or more edges of the flexible mulch mat 10. Accordingly, at least one edge of the second mulch mat 10′ may be placed over the border 16 to form a barrier between the abutted mulch mats 10, 10′ to prevent growth of weeds and grass between the mats 10, 10′. Unused portions of the border 16 may be easily trimmed away; e.g., from edges that are not abutting or underlying another mulch mat 10′. Additionally or alternatively, the unused portions of the border 16 may folded under the mulch mats 10, 10′, for convenience or to preserve the option of later use.

The lower surface of the mulch surface 12 may be described as occupying a plane defining an x-axis and a y-axis. The rubber buffings are randomly oriented and occupy various angular positions relative to the lower planar surface. Said differently, the rubber buffings may be affixed in an irregular arrangement, in which the buffings extend, or project, at a variery of angles (i.e., in the “z”-direction) relative to the lower planar surface (i.e., the “x-y” plane). As a result, the thickness of the mat varies from point to point across the mat, due to the unpredictable array of the rubber components above centrally located transverse plane, which parallels the lower planar surface.

FIG. 5B provides a perspective view of the irregular mass of rubber components that produce the present mulch mats. A portion of the rubber components project from the upper surface, resulting in a non-uniform, rough texture and a realistic appearance. The angular orientation of the rubber buffings within the mat forms an interlocking matrix that enhances the structural integrity of the mat. The use of rubber components of different sizes further contributes to the random contours of the mat and to the creation of non-linear channels throughout the body of the mat for water and moisture transport. As discussed above, the varying thicknesses across the “x-y” plane impart a desirable mulch-like quality.

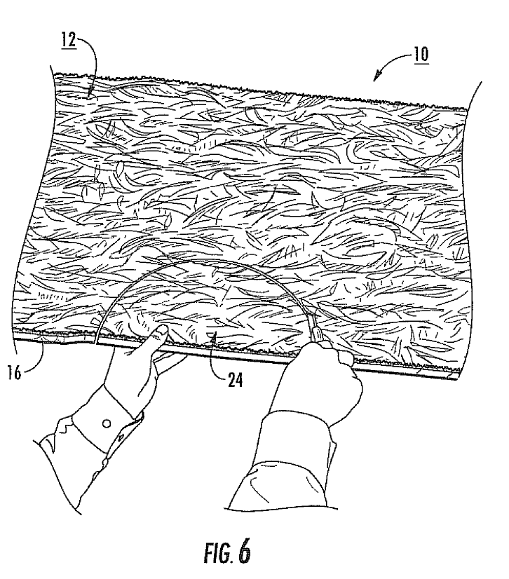

As shown in FIG. 6, the flexible mulch mat 10 is pliable and sufficiently thin in cross-section for a gardener to cut through the surface 12, the base 14 and the border 16 to remove a portion 24 of the flexible mulch mat 10 to fit around part of a tree trunk, a post or the like (see e.g., FIG. 1).

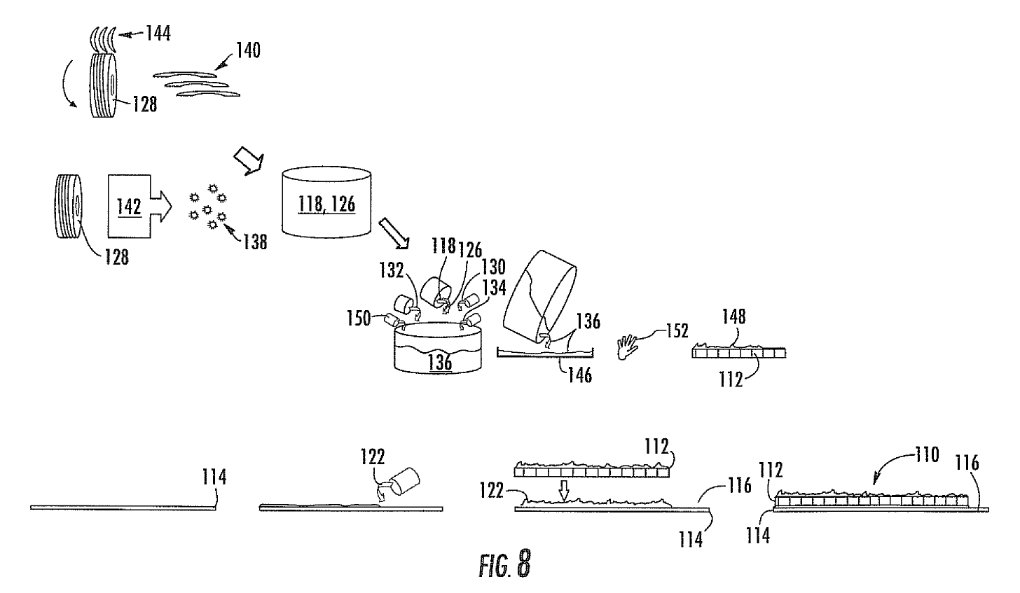

The disclosure may be better understood with reference now to the processes shown in FIGS. 7 and 8. As briefly introduced above and shown here, the mulch mat 10 (or 110) may include rubber shavings or buffings 40 (or 140) and may also include rubber granules 38 (or 138), collectively referred to herein as the rubber components 18 (or 118), and, optionally, fibers 26 (or 126) As shown in FIGS. 7 and 8, the rubber components 18 (or 118) and the fibers 26 (or 126) may be obtained from used tires 28 (or 128), which are processed to produce rubber shavings or buffings 40 (or 140) and/or rubber granules 38 (or 138). The rubber 18 (118), the fibers 26 (126), a curable binder 30 (130), one or more coloring agents or pigments 32 (132), and/or a catalyst 34 (134) are mixed together to form a matrix or mixture 36 (136) used to produce the mulch mat 10 (110).

The rubber components 18 (118) may be derived from used tires or retread pieces, although other rubber sources may be used instead of, or in conjunction with, tires. The shavings or granules may be made of any of various types of rubber, including acrylonitrile-butadiene rubber (NBR), styrene-butadiene rubber (SBR), carboxylated NBR, chlorinated rubber, silicone containing rubber, EPDM and the like. Alternately, the shavings 40 (140) or granules 38 (138) may be made of an elastomer material other than rubber.

When the used tires 28 (128) or retread pieces are ground in a granulator 42 (142), steel or other fiber components are removed, leaving rubber granules 38 (138). Obviously, other rubber or elastomeric sources may not include fiber or other reinforcing constituents. The resulting rubber granules are generally in the range of about ⅛ inch to about ¾ inch in major dimension. The granulator 42 (142) may be adjusted to produce granules of different dimensions, and granules having different dimensions may be used in the same mulch mat.

In one construction, the majority of the rubber components of the mulch mat are rubber shavings or buffings, which may be made to resemble wood shreds or chips and which provide relatively more strength and flexibility to the mat 10 (110). To produce such shavings, or buffings, 40 (140), a buffing machine 44 (144) is rotated about the tire 28 (128) (or vice versa) to shed the buffings 40 (140). The rubber shavings, or buffings, are characterized as having a length greater than their width (e.g., about ¼ inch to about 3 inches in length and about ⅛ inch to about 1 inch in width). According to one aspect provided herein, the shavings 40 (140) and/or granules 38 (138) are of non-uniform size and shape to enhance the natural appearance of the upper mulch surface 12 (112) of the mulch mat 10 (110).

If rayon, nylon, polyaramid, or other such materials were used to reinforce the tires 28 (128), the discrete fibers of such materials may also be the byproduct of shredding, mulching, granulating, or buffing the tires 28 (128). Such fibers may have a length of about 1 inch. Optionally, these fibers 26 (126) may be included with the rubber components 18 (118) in the manufacturing process.

The rubber components are held together by a curable binder (shown as 30 in FIG. 7 and 130 in FIG. 8). The binder 30 (130) may be a latex or a urethane binder, such as moisture-curable polyurethane binder. Binders other than polyurethane (e.g., polyacrylates) may instead be used to adhere the rubber components 18 (118).

To provide a natural appearance to the rubber components, coloring agents 32 (or 132 in FIG. 8) may be incorporated into the mulch mat 10 (110). The coloring agent may be a pigment, such as an iron oxide pigment. The coloring agent(s) 32 (132) may further include an anti-gloss agent or compound to minimize sheen or gloss. Diatomaceous silica may be used as anti-gloss agent. The diatomaceous silica, for instance, may be sprinkled on the surface of the uncured, molded mixture to reduce gloss.

As described with reference to FIGS. 7 and 8, the mulch mat mixture 36, 136 may further include a catalyst 34, 134, respectively. The catalyst may be chosen based on the type of binder system being used.

The skilled artisan will appreciate that these sources and brands are provided by way of example only and that any suitable binder, pigment, anti-gloss additive, catalyst, and the like may be used.

By way of example, the final mixture 36 (136) by weight may contain about 75% to 88% rubber; about 0 to 2% fiber 26 (126); about 10% to about 15% binder 30 (130); about 2 to 5% coloring agent 32 (132) by weight of total binder; about 0.01 to 0.03% catalyst 34 (134) by weight of total binder; and a negligible percentage of UV light stabilizers and anti-oxidants. When making a mat having the appearance of shredded wood mulch, the rubber component may comprise as much as 100% rubber buffings 40 (140). However, when making a mat having the appearance of pebbles or stones, the rubber component may comprise as much as 100% rubber granules 38 (138). Combinations of rubber granules 38 (138) and rubber buffings 40 (140) may also be used to create a varied texture in the mulch mat.

As further shown in the examples of FIGS. 7 and 8, the mixture 36 (or 136) is poured onto a forming surface 46 (146), such as a conveyor belt or a mold, to a thickness ranging from about one 0.100 inches to about 0.250 inches, although other thicknesses can be produced as noted above. More specifically, the forming surface 46 (146) includes edge portions that have a height equal to or slightly heigher than the desired thickness of the finished mulch mat 10 (110). The forming surface 46 (146) also has a width that dictates the width of the surface 12 (112).

FIG. 7 further shows that the mixture 36 may be smoothed with a smoothing device 48—or manually leveled—substantially even with a top of the forming surface 46 to form the surface 12. Smoothing may be most appropriate when forming a mat having a surface intended to resemble pebbles or small stones, which is formed by rubber granules. Simultaneously, or subsequently, the base 14 is prepared by applying a layer of adhesive 22. As shown, the surface 12 is conveyed to the adhesive-coated base 14 and the components are pressed together to form the mulch mat 10. Once the components of the mulch mat 10 are cured together, the mulch mat 10 is rolled up, packaged (such as in shrink wrap) and shipped to retailers.

Alternate means of bonding the surface 12 and the base 14 include heat-pressing the components together using, for instance, a urethane bond. The skilled artisan will further recognize that the base 14 may be transported and applied to the surface 12 rather than as shown in FIG. 7. Moreover, the base 14 could be placed on the forming surface 46 and the heated mixture 36 deposited onto the base 14 to form the mulch mat 10. Thus, the disclosure is not limited to the exemplary manufacturing process shown in FIG. 7.

Turning now to FIG. 8, a process is shown, which is in many ways similar to the process shown in FIG. 7. As briefly introduced above and shown here, a mulch mat 110 may be made of rubber pieces 118, and possibly fibers 126, from used tires or retread pieces 128 or other rubber sources. The rubber pieces 118 may include rubber granules 138 (produced by putting tires 128 through a granulator 142) and rubber buffings 140 (produced by contacting tires 128 with a buffing machine 144).

The rubber 118, (optionally) the fibers 126, a curable binder 130, one or more coloring agents or pigments 132 and/or a catalyst 134 are mixed together to form a matrix or mixture 136 used to generate the mulch mat 110. In this construction, a fertilizer compound 150 may also be added to mixture 136, such that the fertilizer compound 150 is disposed about the rubber components 118. The fertilizer 150 may be organic, inorganic or a combination of organic and inorganic components. Moreover, the fertilizer 150 may be granular, a powder, a liquid, a slow-release fertilizer and combinations of these and other types of fertilizers. The fertilizer compound 150 may be present in an amount from about 1% to about 10% by weight of the mixture. Further, the fertilizer 150 may be added to the surface 112 after it is formed or at most any stage in the process, such as, for example, after use for a period of time to replenish the fertilizing efficacy of the mat 110.

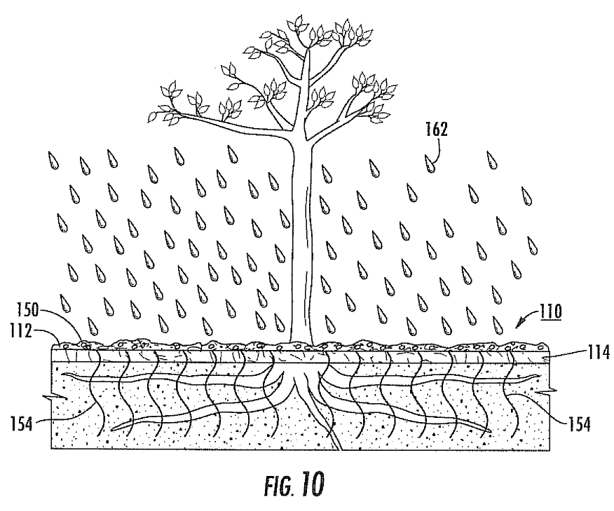

The mixture 136 is poured onto a forming surface 146, such as a conveyor belt or a mold, which dictates the width of the mulch surface 112. FIG. 8 particularly shows that the surface 112 may be manually leveled, as schematically depicted by a hand symbol 152 to form an irregular surface 148. Accordingly, the surface 112 appears as natural mulch. More particularly, each of the rubber pieces 118 appear somewhat different relative to one another in size, shape, orientation and spacing to resemble shredded wood mulch. For instance, as shown in FIG. 10, the surface 112 is jagged and uneven with many rubber buffings projecting from the mat, much as shredded mulch would appear shoveled around a tree.

Simultaneously, or subsequently, the base 114 is prepared by applying a layer of adhesive 122. As shown, the surface 112 is conveyed to the adhesive-coated base 114 and the components are pressed together to form the mulch mat 110. Once the components of the mulch mat 110 are cured together, the mulch mat 110 may be rolled up, packaged (such as in shrink wrap) and shipped to retailers.

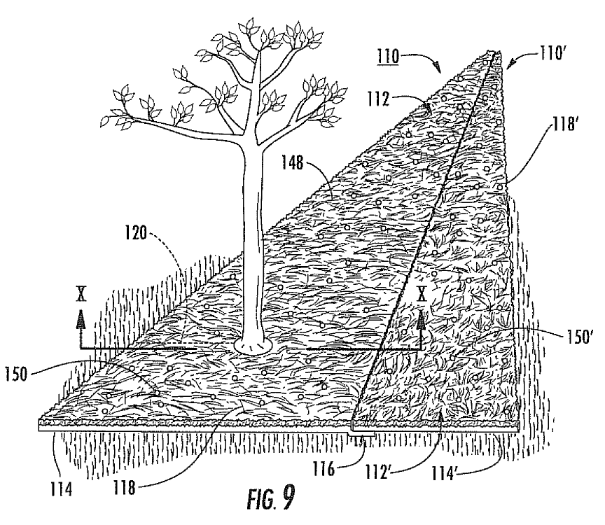

With reference to FIG. 9, the exemplary flexible mulch mat 110 is rectangular in shape and optionally has been slit as indicated by element number 120 to fit around a tree in this example. This illustration shows a configuration that results when a gardener or groundskeeper opts to use another flexible mulch mat, designated by the element number 110′, to create a relatively large covered area. As shown, each of the flexible mulch mats 110, 110′ include respective surfaces 112, 112′ having pieces 118, 118′ as introduced above. As further shown, the flexible mulch mat 110′ overlies a border 116 of the flexible mulch mat 110 to create a weed-blocking barrier between the flexible mulch mats 110, 110′. Without the border 116 between the flexible mulch mats 110, 110′, weeds, grass and other undesired plant life may readily grow between a seam or abutment created between the flexible mulch mats 110, 110′. The border portion of flexible mulch mat 110′ is not shown, such border portion either having been folded under the mat 110′ or having been removed.

FIG. 10 most clearly shows the fertilizer 150 in or on the flexible mulch mat 110. As rain or water 162 contacts the fertilizer 150, the fertilizer 150 activates, such as by becoming a liquid 154, and passes through a fabric or base 114 to nourish tree roots in this example. Also as shown in this example, the surface 112 and the fabric 114 are sufficiently porous to permit the liquid 154 to pass through to the tree roots, but the fabric 114 is of a sufficiently tight weave or permeability to prevent weeds, grass and other undesired plant life from growing through the fabric 114.

It will be appreciated by the skilled artisan that, although fertilizer 150 has been depicted as granules on the surface 112, the fertilizer 150 could be embedded in the various portions of the mulch mat 110. Alternately or additionally, the fertilizer 150 may be a liquid that is incorporated into the mixture 136 to form the surface 112 as in FIG. 8. Once the fertilizer 150 is depleted, perhaps after a season of use, the gardener may replenish the fertilizer 150 by sprinkling or spraying new fertilizer onto the surface 112 where the newly applied fertilizer will leach or seep into the underlying roots as described above.

While preferred embodiments of the disclosure have been shown and described, those skilled in the art will recognize that other changes and modifications may be made to the foregoing examples without departing from the scope and spirit of the disclosure. For instance, dimensions such as areas, lengths, and widths of the mats can be changed to accommodate various lawn and garden requirements. Likewise, the border may be about 1 inch on one side of the mat but less or more on other sides of the mat. Still further, different rubber or other durable elastomeric materials can be used to manufacture the mat described herein. It is intended to claim all such changes and modifications as fall within the scope of the appended claims and their equivalents.

We claim:

1. A flexible mulch mat, comprising:
a first surface including a plurality of rubber components configured to appear as mulch, the rubber components being irregularly sized, shaped and spaced relative to each other;
a second surface in contact with the first surface, the second surface being configured for contact with ground to prevent plant growth therethrough;
a section depending from the second surface and extending beyond the first surface, the section being configured to underlie an abutment to prevent plant growth therethrough; and
a fertilizer disposed about the rubber components, the fertilizer configured to leach through the second surface to the ground.

2. The flexible mulch mat as in claim 1, wherein the rubber components of the first surface are selected from the group consisting of rubber buffings and rubber granules.

3. The flexible mulch mat as in claim 2, wherein the rubber buffings and rubber granules are derived from rubber tires.

4. The flexible mulch mat as in claim 1, wherein the second surface is selected from the group consisting of a polypropylene material, a polyethylene material, a polyester material and combinations thereof.

5. The flexible mulch mat as in claim 1, wherein the first and second surfaces are between about 0.100 inches to about 0.250 inches in cross-section.

6. The flexible mulch mat as in claim 1, wherein the first surface is about 12 inches to about 48 inches in width.

7. The flexible mulch mat as in claim 1, wherein the first surface is about 4 feet to about 10 feet in length.

8. The flexible mulch mat as in claim 1, wherein the second surface projects beyond the first surface from about 1 inch to about 2 inches.

9. The flexible mulch mat as in claim 1, wherein the abutment is formed between the flexible mulch mat and an adjoining mulch mat.

10. The flexible mulch mat as in claim 1, further comprising an adhesive being configured to adhere the first surface to the second surface.

11. A method of manufacturing a flexible mulch mat, comprising:
providing a forming surface;
mixing together a rubber component and a binder to form a matrix having a mulch-like appearance; and
attaching a base to the matrix to form a flexible mat on the forming surface.

12. The method as in claim 11, further comprising mixing a fertilizer in the matrix.

13. The method as in claim 11, further comprising applying a fertilizer to the flexible mat.

14. The method as in claim 11, further comprising forming a border depending from the base beyond the matrix.

15. The method as in claim 11, further comprising rolling the mat into a tubular form.

16. The method as in claim 11, further comprising rolling the mat into a tubular form having a diameter of about five inches to about ten inches.
